(19) United States
(12) Patent Application Publication
(10) Pub. No.: US 2022/0183287 A1
(43) Pub. Date: Jun. 16, 2022

(54) METHODS FOR KILLING PESTS

(71) Applicant: The United States of America, as represented by the Secretary of Agriculture, Washington, DC (US)

(72) Inventors: SUSAN L. MEYER, COLUMBIA, MD (US); AIJUN ZHANG, LAUREL, MD (US); MARGARET H. MACDONALD, LAUREL, MD (US); YAN FENG, BOWIE, MD (US)

(21) Appl. No.: 17/546,331

(22) Filed: Dec. 9, 2021

Related U.S. Application Data
(60) Provisional application No. 63/123,615, filed on Dec. 10, 2020.

(51) Int. Cl. A01N 37/10; A01N 37/18; A01N 25/02; A01N 33/18

(52) U.S. Cl. CPC A01N 37/10; A01N 33/18; A01N 25/02; A01N 37/18

(57) ABSTRACT

The present disclosure provides methods for killing pests such as nematodes, oomycetes, and fungi, involving treating an object or area with an effective amount of a composition containing at least one compound of formula 1, wherein R1 is CH₃, C₂H₅, C₃H₇; saturated or unsaturated, straight or branched, or halogen substituted alkyl; and wherein R2 are independently H, halogen, nitrogen, oxygen, sulfur, saturated or unsaturated, straight or branched alkyl, alkenyl, alkyl halide, aldehyde, ketone, ether, ester, amine, or amide; optionally methyl benzoate, optionally a surfactant, and optionally a carrier.

### CROSS-REFERENCE

The present application claims priority to U.S. Provisional Patent Application Ser. No. 63/123,615 filed Dec. 10, 2020, the content of which is expressly incorporated herein by reference.

### BACKGROUND OF THE INVENTION

### Background

Pests such as plant-parasitic nematodes are major pathogens of cash crops, causing an estimated $157 billion dollars in yield losses globally (Singh, S., et al., Procedia Environ. Sci., 29: 215-216 (2015)). Root-knot (Meloidogyne spp.) and cyst (Heterodera spp.) nematodes are two of the most economically and scientifically important genera (Jones, J. T., et al., Mol. Plant Pathol., 14:946-961 (2013)). Root-knot nematodes have a broad host range, and although they are responsible for ˜5% of crop losses worldwide, technology for controlling them has advanced little in the last 30 years (McCarter, J. P., Nature Biotech., 26: 882-884 (2008)). In particular, M. incognita (RKN) has a very broad range of host plants, attacking up to 3,000 species (Castagnone-Sereno, P., Euphytica, 124: 193-199 (2002)). Heterodera glycines (SCN) is the most economically important pathogen on soybeans with estimates of yield losses in the United States ranging from 93,981,000 bushels to 171,997,000 bushels per year (Koenning, S. R., and J. A. Wrather, Suppression of soybean yield potential in the continental United States by plant diseases from 2006 to 2009, Plant Health Progress (2010)). These losses demonstrate that novel strategies are needed for managing these pathogens.

Nematicides are often very toxic chemicals which kill even non-target nematodes in soil (Chitwood, D. J., 2003, Nematicides, Pages 1104-1115, IN: J. R. Plimmer, ed., Encyclopedia of Agrochemicals, Vol. 3, New York, John Wiley & Sons). Methyl bromide has been used for decades as a soil sterilizer to control nematodes, fungi, stramenopiles (oomycetes), weeds, and insects in soil that is used for the production of high value agricultural crops such as strawberries, tomatoes, peppers, orchard crops, and vine crops; however, it is very damaging to the ozone layer and is being phased out (Santos, B. M., and J. P. Gilreath, CAB Reviews: Perspectives in Agriculture, Veterinary Science, Nutrition and Natural Resources, 1: 57 (2006)). Detailed below are other compounds that have been evaluated as alternatives to methyl bromide; however, these are all toxic, flammable, or have other negative issues regarding their use or their production: dimethyl disulfide (Heller, J. J., et al., Acta Horticulturae, 842: 953-956 (2009)); ozone (Qiu, J. J., et al., J. of Nematol., 41(3): 241-246 (2009)); methyl iodide (Farwell, A. P., and J. L. Leonard, Inhalation Toxicol., 21(6): 497-504 (2009)); allyl isothiocyanate (Bangarwa, S. K., et al., Weed Tech., 25(1): 90-96 (2011));ethyl formate (Yang, J. O., et al., J. of Econ. Entomol., 109(6): 2355-2363 (2016)); phosphine (Yang, J. O., et al., J. of Econ. Entomol., 109(6): 2355-2363 (2016)); chloropicrin (Ceustermans, A., et al., Acta Horticulturae, 883: 135-144 (2010)); metam sodium/potassium (Ceustermans, A., et al., Acta Horticulturae, 883:135-144 (2010)); 1,3-dichloropropene (Ceustermans, A., Acta Horticulturae, 883: 135-144 (2010)); and dazomet (Ceustermans, A., et al., Acta Horticulturae, 883: 135-144 (2010)). Steam has been used to sterilize soil; unfortunately, its use entails high cost (Rainbolt, C. M., et al., HortTechnology, 23(2): 207-214 (2013)).

Thus, there continues to be a need for safe, environmentally friendly pesticides (e.g., nematicides). It is desirable to produce green pesticides (e.g., nematicides) in order to reduce the use of widely used toxic synthetic pesticides. Presented herein, we provide new pesticidal agents and methods of their use.

### SUMMARY OF THE INVENTION

The present disclosure provides a method for killing nematodes, said method comprising (or consisting essentially of or consisting of) treating an object or area with a nematode killing effective amount of a composition comprising (or consisting essentially of or consisting of) at least one compound of formula 1

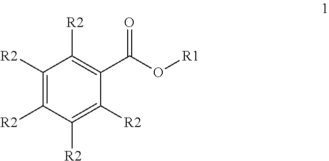

wherein R1 is CH₃, C₂H₅, C₃H₇; saturated or unsaturated, straight or branched, or halogen substituted alkyl; and wherein R2 are independently H, halogen, nitrogen, oxygen, sulfur, saturated or unsaturated, straight or branched alkyl, alkenyl, alkyl halide, aldehyde, ketone, ether, ester, amine, or amide; optionally methyl benzoate, optionally a surfactant, and optionally a carrier. In some embodiments, the optional carrier is selected from the group consisting of water, mineral oil, and mixtures thereof. In some embodiments of this method, the composition utilized consists essentially of at least one compound of formula 1, optionally methyl benzoate, optionally a surfactant, and optionally a carrier. In some embodiments, the composition utilized consists of at least one compound of formula 1, optionally methyl benzoate, optionally a surfactant, and optionally a carrier. In some embodiments, this method consists essentially of treating an object or area with a pest killing effective amount of a composition consisting essentially of at least one compound of formula 1, optionally methyl benzoate, optionally a surfactant, and optionally a carrier. In some embodiments, this method consists essentially of treating an object or area with a pest killing effective amount of a composition consisting of at least one compound of formula 1, optionally methyl benzoate, optionally a surfactant, and optionally a carrier. In some embodiments, this method consists of treating an object or area with a pest killing effective amount of a composition consisting of at least one compound of formula 1, optionally methyl benzoate, optionally a surfactant, and optionally a carrier. In some embodiments, the compound of formula 1 utilized in practicing this method is the sole pesticide in said composition, or is optionally used in combination with methyl benzoate. In some embodiments, the pests are nematodes, oomycetes or fungi. In some embodiments, the pests are nematodes.

### INCORPORATION BY REFERENCE

All publications, patents and patent applications mentioned in this specification are herein incorporated by reference to the same extent as if each individual publication, patent, or patent application was specifically and individually indicated to be incorporated by reference. Also incorporated by reference in their entirety are the following references: Jawale, P. V., and B. M. Bhanage, Synthesis of propyl benzoate by solvent-free immobilized lipase-catalyzed transesterification: Optimization and kinetic modeling, Bioprocess and Biosystems Engineering (2020); Marengo, E., et al., J. Chromatography A, 1029: 57-65 (2004); Selles, A. J. N., et al., J. Ag. and Food Chem., 50:762-766 (2002); U.S. Pat. Nos. 7,109,380; and 8,871,280.

### BRIEF DESCRIPTION OF THE DRAWINGS

The novel features of the invention are set forth with particularity in the claims. Features and advantages of the present invention are referred to in the following detailed description, and the accompanying drawings of which:

FIG. 1 shows the chemical structures of DEET (for comparison with an insecticide), methyl benzoate (MB), and other compounds tested in this study as described below.

Compounds with an * are naturally occurring compounds (Feng, Y., and A. Zhang, et al., Scientific Reports, 7: 42168 (2017)). All of the compounds listed are commercially available.

### DETAILED DESCRIPTION OF THE INVENTION

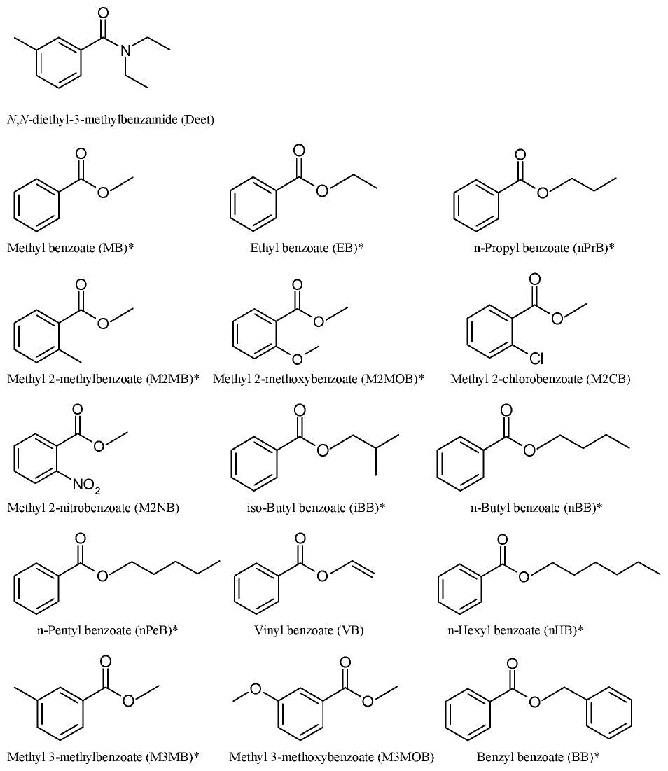

The compounds tested in this study included methyl benzoate (MB) and other compounds. MB shares a chemical skeleton with the benzamide DEET (FIG. 1), which is an arthropod repellent (Feng, Y., et al., Sci. Rep., 8:7902 (2018)). In prior research, MB and various naturally occurring and synthetic compounds were toxic against insect pests, including insects that attack plants (Feng, Y., and A. Zhang, Sci. Rep., 7:42168 (2017); U.S. Pat. No. 9,629,362; Feng et al., 2018; Chen, J., et al., J. Econ. Entomol., 112: 691-698 (2019); Morrison, W. R. III, et al., J. of Econ. Entomol., 112: 2458-2468 (2019); U.S. Patent Application Publication No. 20190216084; Larson, N., et al., J. of Med. Entomol., 57: 187-191 (2020); Yang, X., et al., J. of Applied Entomol., 144: 191-200 (2020)).

However, demonstration of activity against insects does not indicate that the same compounds will be nematotoxic or otherwise active against pests such as nematodes, especially when applied to soil to suppress nematode populations. MB isolated from aerial plant parts of Buddleja crispa (Himalayan butterfly bush) demonstrated nematocidal activity against M. incognita juveniles in laboratory assays (Sultana, N., et al., Natural Product Research, 24: 783-788 (2010)). However, this study did not include tests with nematodes on plant roots, so it is not known that this compound is effective in soil. Benzyl benzoate (BB) and other compounds produced by the bacterium Bacillus nematocida attract Caenorhabditis elegans (Niu, Q., et al., PNAS, 107: 16631-16636 (2010)). The nematode eats the bacterium, which is then pathogenic from within the nematode through secretion of bacterial extracellular proteases which target essential intestinal proteins of the nematode. BB was therefore shown to be a nematode attractant. In general, when considering potential nematotoxicity of compounds, it is important to note that previous studies with other natural compounds indicated that there was not always a high correlation in nematotoxicity between H. glycines and M. incognita (Meyer, S. L. F., et al., Nematol., 6: 23-32 (2004)).

Similarly, the natural compound 2,4-diacetylphloroglucinol (DAPG) was tested against seven different nematode genera: the plant-parasitic nematodes Heterodera glycines, Meloidogyne incognita, Pratylenchus scribneri and Xiphinema americanum, and the bacterial-feeding nematodes Caenorhabditis elegans, Pristionchus pacificus, and Rhabditis rainai (Meyer, S. L. F. et al., J. Nematol., 41: 274-280 (2009)). DAPG was toxic to X americanum adults and decreased egg hatch of M. incognita, but stimulated hatch of C. elegans during the first hours of incubation. The prior art concluded that nematode viability was not affected and indicated that DAPG is not toxic to all nematodes. Thus, it should not be assumed that a compound toxic to insects is also toxic to nematodes, especially when applied to soil.

We have previously reported (see, e.g., U.S. Pat. No. 9,629,362) that a volatile organic compound (VOC) component, methyl benzoate (MB) identified from fermented apple juice, exhibited significant toxicity or sublethal effect against some insect pests, including invasive fruit-infesting fly, spotted wing drosophila Drosophila suzukii Matsumura, brown marmorated stinkbug Halyomorpha halys, diamondback moth Plutella xylostella, and tobacco hornworm Manduca sexta (Feng, Y., and A. Zhang, Sci. Rep., 7: 42168 (2017)). However, it was surprising that these types of compounds would have lethal activity against pests such as nematodes, oomycetes, and fungi. Herein, we detail new methods for using these compounds.

Disclosed herein are methods for killing pests (e.g., nematodes, oomycetes, and fungi), involving treating an object or area with a pest killing effective amount of a composition containing at least one compound of formula 1:

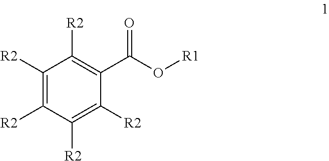

wherein R1 is CH₃, C₂H₅, C₃H₇; saturated or unsaturated, straight or branched, or substituted short chain alkyl (e.g., C1 to C10, preferably C1 to C6; e.g., vinyl, isopropyl, pentyl; alkyl substituted with a halogen such as fluoromethyl, 3-chloropentyl); and wherein R2 are independently H, halogen (e.g., F, Cl, Br, I; such as methyl 2-fluorobenzoate), nitrogen (e.g., methyl 2-nitrobenzoate), oxygen (e.g., methyl 2-methoxybenzoate), sulfur (e.g., methyl 2-methylthiobenzoate); saturated or unsaturated, straight or branched alkyl (e.g., C1 to C10, preferably C1 to C6; such as methyl 2-isobutylbenzoate), alkenyl (e.g., C1 to C10, preferably C1 to C6; such as methyl 2-isobutenylbenzoate), alkyl halides (e.g., C1 to C10, preferably C1 to C6; such as methyl 2-(2-chloroethyl)benzoate, aldehyde (e.g., C1 to C10, preferably C1 to C6; such as methyl 2-(2-oxoethyl)benzoate, ketone (e.g., C1 to C10, preferably C1 to C6; such as methyl 2-acetylbenzoate), ether (e.g., C1 to C10, preferably C1 to C6; such as methyl 2-(methoxymethyl)benzoate, ester (e.g., C1 to C10, preferably C1 to C6; such as methyl 2-[(acetyloxy)methyl]benzoate, amine (e.g., C1 to C10, preferably C1 to C6; such as methyl 2-aminobenzoate), or amide (e.g., C1 to C10, preferably C1 to C6; such as methyl 2-(aminocarbonyl)benzoate. More preferably R1 is methyl and R2 are hydrogens. All of these compounds can be made by a standard synthetic procedure called “Fischer esterification” utilizing corresponding benzoic acids, acid chlorides, or acid anhydrides and reacting with corresponding alcohols in the presence of an acid catalyst (Fischer, E., and A. Speier, “Darstellung der Ester”, Chemische Berichte, 28: 3252-3258 (1895)). The composition also contains optionally methyl benzoate, optionally a surfactant, and optionally a carrier.

Compositions containing one or more (e.g., two) of these compounds may contain one specific compound or may not contain that specific compound. For example, a composition could contain methyl 2-nitrobenzoate, or the composition may not contain methyl 2-nitrobenzoate. Another example, a composition could contain methyl 2-methylthiobenzoate and methyl 2-[(acetyloxy)methyl]benzoate, or the composition may not contain methyl 2-[(acetyloxy)methyl]benzoate.

Those working in this field would be readily able to determine in an empirical manner which organisms may be killed or eliminated by the composition. Plant-pathogenic organisms (pests) successfully controlled or eliminated by treatments in accordance with the present invention include, but are not limited to, nematodes, oomycetes, and fungi; for example, nematodes (e.g. Meloidogyne spp. (root-knot), Xiphinema spp. (dagger), Pratylenchus (lesion), Longidorus spp. (needle), Paratylenchus spp. (pin), Rotylenchulus spp. (reniform), Helicotylenchus spp. (spiral), Hoplolaimus spp. (lance), Paratrichodorus spp. (stubby root), Tylenchorhynchus spp. (stunt), Radopholus spp. (burrowing), Anguina spp. (seed gall), Aphelenchoides spp. (folair), Bursaphelenchus spp. (pinewood), Ditylenchus spp. (stem, bulb, and potato rot), Trichodorus spp., Globodera spp. (potato cyst), Hemicycliophora spp. (sheath), Heterodera spp. (cyst), Dolichodorus spp. (awl), Criconemoides spp. (ring), Belonolaimus spp. (sting), Tylenchulus semipenetrans (citrus). Particular plant pathogens and nematodes controlled or eliminated by application of the composition include, but are not limited to, the following: root-rot pathogens (e.g., Phytophthora spp., Pythium spp., Rhizoctonia spp., Fusarium spp.); vascular wilt pathogens (e.g., Verticillium spp., Fusarium spp.); root-knot and ectoparasitic nematodes (e.g., Meloidogyne spp., Pratylenchus spp., Rotylenchus spp., Tylenchorrhynchus spp., Xiphinema spp.); root lesion nematodes (e.g., Pratylenchus vulnus); ring nematodes (e.g., Circonemella xenoplax); stubby root nematodes (e.g., Paratrichodorus spp.); stem and bulb nematodes (e.g., Ditylenchus dipsaci); cyst nematodes (e.g., Heterodera schachtii); citrus nematodes (e.g., Tylenchulus semipenetrans); and burrowing nematodes (e.g., Radopholus similus). Important plant-pathogenic oomycetes include, but are not limited to Phytophthora infestans, Phytophthora ramorum, Phytophthora capsici, Phytophthora nicotianae, Pythium aphanidermatum, Pythium myriotylum, Pythium ultimum, and Hyaloperonospora parasitica. The oomycetes are filamentous protists that belong to the Kingdom Chromista and were once considered fungi, but based on cell wall composition, the diploid nature of their nuclei, flagella structure and chloroplast endoplasmic reticulum, they are now considered members of a distinct Kingdom.

The compositions according to the invention are active in particular against fungi, particularly of the following non-limiting types: basidiomycetes, ascomycetes, adelomycetes, deuteromycetes or imperfect fungi such as Botrytis cinerea, Colletotrichum fragariae, Colletotrichum acutatum, Colletotrichum gloesporiodes, Erysiphe graminis, Puccinia recondita, Piricularia oryzae, Cercospora beticola, Puccinia striiformis, Erysiphe cichoracearum, Fusarium oxysporum (melonis, for example), Pyrenophora avenae, Septoria tritici, Venturia inaequalis, Whetzelinia sclerotiorum, Monilia taxa, Mycosphaerella fijiensis, Marssonina panettoniana, Alternaria solani, Aspergillus niger, Cercospora arachidicola, Cladosporium herbarum, Helminthosporium oryzae, Penicillium expansum, Pestalozzia sp., Phialophora cinerescens, Phoma betae, Phoma foveata, Phoma lingam, Ustilago maydis, Verticillium dahliae, Ascochyta pisi, Guignardia bidwellii, Corticium rolfsii, Phomopsis viticola, Sclerotinia sclerotiorum, Sclerotinia minor, Coryneum cardinale, Rhizoctonia solani, and Phomopsis obscurans.

Additional non-limiting fungal species against which compounds and methods of the present disclosure are active include: Acrostalagmus koningi, Alternaria, Colletotrichum, Diplodia natalensis, Gaeumannomyces graminis, Gibberellafujikuroi, Hormodendron cladosporioides, Lentinus degener or tigrinus, Lenzites quercina, Memnoniella echinata, Myrothecium verrucaria, Paecilomyces variotii, Pellicularia sasakii, Phellinus megaloporus, Polystictus sanguineus, Poria vaporaria, Sclerotium rolfsii, Stachybotris atra, Stereum, Stilbum sp., Trametes trabea, Trichoderma pseudokoningi, and Trichothecium roseum.

A carrier component (e.g., agronomically or physiologically or pharmaceutically acceptable carrier) can be a liquid or a solid material, if utilized in any embodiment. The term “carrier” as used herein includes carrier materials such as those described below. As is known in the art, the vehicle or carrier to be used refers to a substrate such as a mineral oil, paraffin, silicon oil, water, membrane, sachets, disks, rope, vials, tubes, septa, resin, hollow fiber, microcapsule, cigarette filter, gel, fiber, natural and/or synthetic polymers, elastomers or the like. All of these substrates have been used to controlled release effective amount of a composition containing the compounds disclosed herein in general and are well known in the art. Suitable carriers are well-known in the art and are selected in accordance with the ultimate application of interest. Agronomically acceptable substances include aqueous solutions, glycols, alcohols, ketones, esters, hydrocarbons halogenated hydrocarbons, polyvinyl chloride; in addition, solid carriers such as clays, laminates, cellulosic and rubber matrices and synthetic polymer matrices, or the like.

The term “pesticidal”, and grammatical variations thereof, refers to the ability of a composition of the present invention to kill pests (e.g., nematodes), when present in an effective amount.

The terms “object” or “area” as used herein include any place where the presence of pests (e.g., nematodes) are not desirable, including any type of premises, which can be out-of-doors, such as in farms, orchards, parks, yards, gardens, lawns, tents, camping bed nets, camping areas, forests, and so forth, or indoors, such as in barns, garages, commercial buildings, homes, silos, grain storage, and so forth, or any area where pests are a problem, such as in shipping or storage containers (e.g., luggage, bags, boxes, crates, etc.), packing materials, bedding, and so forth; also includes clothing.

The amount of the compounds described herein, or compositions described herein, to be used will be at least an effective amount. The term “effective amount,” as used herein, means the minimum amount of the compounds or compositions needed to kill the pests (e.g., nematodes) when compared to the same area or object which is untreated. Of course, the precise amount needed will vary in accordance with the particular composition used; the type of area or object to be treated; and the environment in which the area or object is located. The precise amount of the composition can easily be determined by one skilled in the art given the teaching of this application. For example, one skilled in the art could follow the procedures utilized below; the composition would be statistically significant in comparison to a negative control. The compounds described herein, or compositions described herein, to be used will be at least an effective amount of the compound(s) or diluted solution of the compound; for fumigation the compounds used may have to be pure form (not mixed or adulterated with any other substance or material). Generally, the concentration of the compounds will be, but not limited to, about 0.025% to about 10% (e.g., 0.025 to 10%, for example in an aqueous solution), preferably about 0.5% to about 4% (e.g., 0.5 to 4%), more preferably about 1% to about 2% (e.g., 1 to 2%). The composition may or may not contain a control agent for pests (e.g., nematodes), such as a pest biological control agent or a pesticide (e.g., nematicide) known in the art to kill pests.

“Optional” or “optionally” means that the subsequently described event or circumstance may or may not occur, and that the description includes instances in which said event or circumstance occurs and instances where it does not. For example, the phrase “optionally comprising an attractant (e.g., for pests such as nematodes)” means that the composition may or may not contain an attractant and that this description includes compositions that contain and do not contain an attractant.

Other compounds (e.g., pest attractants (such as nematode attractants) or other pesticides (such as nematicides) known in the art) may be added to the composition provided they do not substantially interfere with the intended activity and efficacy of the composition; whether or not a compound interferes with activity and/or efficacy can be determined, for example, by the procedures utilized below.

While this invention may be embodied in many different forms, there are described in detail herein specific embodiments of the invention. The present disclosure is an exemplification of the principles of the invention and is not intended to limit the invention to the particular embodiments illustrated. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The embodiments illustratively disclosed herein suitably may be practiced in the absence of any element [e.g., method (or process) steps or composition components)] which is not specifically disclosed herein. Thus, the specification includes disclosure by silence. Written support for a negative limitation may also be found through the absence of the excluded element in the specification, known as disclosure by silence. Silence in the specification may be sufficient to establish written description support for a negative limitation.

The methods disclosed herein utilize compositions of formula 1 but discloses the use of one or more of compounds fitting that formula. Thus, compositions utilized can have 1 or more than 1 compound of formula 1 (e.g., 2, 3, 4, 5, or more). Disclosed methods can utilize any compound, or exclude any compound from the composition used to target pests (e.g., nematodes). For example, a composition contemplated herein can specifically contain, or specifically not contain the exemplary compounds ethyl benzoate (EB), n-propyl benzoate (nPrB), methyl 2-methylbenzoate (M2MB), methyl 2-methoxybenzoate (M2MOB), methyl 2-chlorobenzoate (M2CB), methyl 2-nitrobenzoate (M2NB), iso-butyl benzoate (iBB), n-butyl benzoate (nBB), n-pentyl benzoate (nPeB), vinyl benzoate (VB), n-hexyl benzoate (nHB), methyl 3-methylbenzoate (M3MB), methyl 3-methoxybenzoate (M3MOB), benzyl benzoate (BB), and methyl benzoate (MB). Certain compositions utilized in practicing the methods disclosed herein do not contain 3-(Dimethylamino) propyl benzoate.

Having generally described this invention, the same will be better understood by reference to certain specific examples, which are included herein to further illustrate the invention and are not intended to limit the scope of the invention as defined by the claims.

### EXAMPLES

The present disclosure provides methods for using compounds (11 of which are natural products; FIG. 1) and combinations (including with MB) for killing plant-parasitic nematodes. For these studies, laboratory assays were conducted with eggs and previously hatched second-stage juveniles (J2) of M. incognita and H. glycines immersed in the compounds and controls. These stages are important for managing phytoparasitic nematodes because egg masses are present on plant roots, and J2 are the infective stage that hatch from the eggs, move through the soil, and invade plant roots. Because of potential dissimilarity in activity between nematode taxa (Meyer, S. L. F., et al., Nematology, 6: 23-32 (2004)), both species were tested to determine effects of novel nematode-antagonistic compounds. Additionally, greenhouse studies were conducted to determine whether M. incognita populations were suppressed on plant roots in the soil.

Nematode cultures: As described in Meyer et al. (Meyer, S. L. F., et al., Nematropica, 46: 85-96 (2016)), M. incognita race 1 (originally isolated in Maryland) was maintained in a greenhouse (24° to 29° C.; natural and supplemental lighting combined for a 16-h daylength) on susceptible cayenne pepper (Capsicum annuum) TA-136′ plants. All greenhouse experiments described herein were conducted under the same conditions. Two to three months after pepper plant inoculation, egg masses were picked from roots. Eggs were separated by 5 min immersion in 0.6% sodium hypochlorite, followed by a rinse in sterile distilled water (SDW). To collect second-stage juveniles (J2) for microwell assays, the surface-sterilized eggs were placed in a hatching chamber (Spectra/Mesh Nylon Filter, openings 25-μm-diam.; Spectrum Laboratories Inc., Rancho Dominguez, Calif.) set in an autoclaved dish that was placed on a rotary shaker for 3 days at 35 rpm. For some M. incognita and H. glycines assays, 25 or 50 pg/m1 kanamycin monosulfate (Phytotechnology Laboratories, Shawnee Mission, Kans.) was added to the hatching chamber to prevent growth of bacteria. The collected J2 were then rinsed with water to remove the kanamycin monosulfate.

The isolate of H. glycines race 3, originally isolated in Maryland, was maintained on soybean (Glycine max cv. ‘Essex’). As previously described (Wen, Y., et al. Plant Disease, 103: 2191-2198 (2019)), the roots were gently rubbed in water to dislodge cysts and mature females. The egg suspensions were then poured through nested sieves (#20 over /#60; pore sizes 850 μm and 250 μm diam., respectively) into a 454 g/liter sucrose solution. After 15 min, the cysts and females and cysts that floated to the top were collected, rinsed in water, and crushed with a rubber stopper on a #60 sieve (250-μm diam. pore size) that was partially submerged in distilled water. The egg suspension was washed through nested #230 over #500 sieves (pore sizes 63 μm and 25-μm diam., respectively). The eggs were collected in distilled water, and J2 hatched as described above.

Microwell assays: Compounds used for the assays are listed in Table 1 and FIG. 1. These compounds were selected for various differences: some differed from MB in number of carbons of aliphatic ester moiety, some were selected for differences in position or functional group of aromatic substances, and others differed from each other in functional group of aliphatic ester moiety. Legend for Table 1: a) compounds differ from each other in number of carbons of aliphatic ester moiety. The number of carbons is indicated in parentheses; b) compounds differ from each other in position or functional group of aromatic substitutions; c) compounds differ from each other in functional group of aliphatic ester moiety.

TABLE 1
Compounds tested against nematodes

| | |
|---|---|
| Methyl benzoate: | MB (1 C)^{a} |
| Ethyl benzoate: | EB (2 C)^{a} |
| n-Propyl benzoate: | nPrB (3 C)^{a} |
| n-Butyl benzoate: | nBB (4 C)^{a} |
| n-Pentyl benzoate: | nPeB (5 C)^{a} |
| n-Hexyl benzoate: | nHB (6 C)^{a} |
| Methyl 2-chlorobenzoate: | M2CB^{b} |
| Methyl 2-methylbenzoate: | M2MB^{b} |
| Methyl 3-methylbenzoate: | M3MB^{b} |
| Methyl 2-methoxybenzoate: | M2MOB^{b} |
| Methyl 3-methoxybenzoate: | M3MOB^{b} |
| Methyl 2-nitrobenzoate: | M2NB^{b} |
| Benzyl benzoate: | BB^{c} |
| iso-Butyl benzoate: | iBB^{c} |
| Vinyl benzoate: | VB^{c} |

Compounds for the studies were purchased from three different companies: methyl benzoate, CAS Number 93-58-3, ≥99% purity; Tween 20, CAS Number: 9005-64-5; Tween 80, CAS Number: 9005-65-6; ethyl benzoate, CAS Number: 93-89-0, natural, ≥99% purity, FCC, FG; vinyl benzoate, CAS Number: 769-78-8, ≥99% purity; n-propyl benzoate, CAS Number: 2315-68-6, 99% purity; n-butyl benzoate, CAS Number: 136-60-7, 99% purity; benzyl benzoate, CAS Number: 120-51-4, natural, ≥99% purity, FCC, FG; methyl 2-methylbenzoate, CAS Number: 89-71-4, 99% purity; methyl 2-chlorobenzoate, CAS Number: 610-96-8, ≥98% purity; methyl 2-methoxybenzoate, CAS Number: 606-45-1, 99% purity and methyl 2-nitrobenzoate, CAS Number: 606-27-9, 98% purity were purchased from Sigma-Aldrich (St. Louis, Mo.). Compounds, iso-butyl benzoate, CAS Number 120-50-3, >98% purity; n-pentyl benzoate, CAS Number: 2049-96-9, ≥98% purity; and n-hexyl benzoate, CAS Number: 6789-88-4, ≥98% purity were purchased from Alfa Aesar (Tewksbury, Mass.). The compounds methyl 3-methoxybenzoate (methyl m-anisate), CAS Number: 5368-81-0; 97% and methyl 3-methylbenzoate (methyl m-toluate), CAS Number: 99-36-5, 97% purity were purchased from TCI America (Portland, Oreg.). All chemicals were used without further purification. Deionized water (DI) containing 1% emulsifier (v/v), Tween 20 and Tween 80, at 1:1 ratio was used to make different VOCs (volatile organic compounds) water solutions and also used as blank control.

For tests with individual compounds, the concentration of each compound was 0.1% before placement into wells; the final concentration in the wells was 0.095% after addition to eggs or J2 suspended in water. These are reported as 0.1% herein. An exception was Trial 2, M. incognita J2 activity and viability (Table 2): the final concentration was 0.1% after placement in wells. For assays that included combinations of compounds, the final concentrations of all treatments are as listed in the tables. Low concentrations were selected for assays of combined compounds to determine if the combinations would increase nematotoxicity.

Laboratory assays were conducted in 96-well polystyrene plates following general procedures described in Wen et al. (2019). Each well received approximately 35 J2 (for previously hatched J2 assays) or 35 eggs that each contained either a first-stage juvenile (J1) or a J2. The plates were covered with plastic adhesive sealing film (Excel Scientific, Inc., Victorville Calif.) and then with the plate lids. Parafilm (Bemis, Neenah, Wis.) was used to seal the plates. The nematodes were then incubated at 26° C. For assays with previously hatched J2, counts of active J2 (showing any movement within 5 seconds) vs. inactive J2 (no movement after 5 seconds) were made after one and/or two days of incubation (Day 1 and Day 2). Following the counts on Day 2, the treatments were removed and the J2 rinsed twice with SDW and incubated in the second rinse. Activity of the rinsed J2 was counted again the next day (Day 3 rinsed) to determine whether the compounds were nematostatic or nematotoxic: J2 inactive after rinsing were considered nonviable. For assays with eggs, the total number of hatched J2 per well, and the numbers of active and inactive J2 in each well, were counted on Days 2, 5 and 7 of incubation. Two trials were conducted for each assay.

Greenhouse trials: Selected compounds and combinations were tested for effects on plant growth and on numbers of galls produced by M. incognita infecting cucumber (Cucumis sativus) plants in pots. Cucumber “Sweet Slice” seeds were planted in ProMix in 6-pack cell trays. Treatments were mixed into loamy sand at 27 ml (Trial 1) and 28 ml (Trial 2) per 300 grams soil. Meloidogyne incognita eggs were mixed into soil for a final inoculum of 5,000 per pot. Each pot received 300 grams soil per treatment, with 4 replicates per treatment in each of two trials. Pots were covered with black plastic and periodically watered to keep the soil moist. Two weeks later, one 14-day old cucumber seedling was transplanted into each pot. Two weeks after transplant, the plants were harvested. Root and shoot measurements were recorded and root galls were counted.

Statistical analyses: The data were analyzed as either a general linear model using JMP or a generalized linear model for the best distribution to fit the residual using Proc Glimmix (Sas Institute). The assumptions of the model were checked. If not met, then appropriate statistical techniques were used so that data could met the assumptions of the models. In Sas, mean comparisons were done with Sidak adjusted p-values to hold the experiment-wise error at 0.05. As indicated in the footnote to Table 5, an analysis from greenhouse trials was conducted with JMP using a Wilcoxon test with each pair nonparametric multiple comparisons (P≤0.05).

Results

Microwell assays with M. incognita: When previously hatched J2 were immersed in the compounds, MB and surprisingly all but two other compounds (nHB and BB) were nematotoxic (Table 2). Most of the treatments surprisingly reduced % active J2 by Day 1. All but six of the treatments surprisingly killed 100% of M. incognita J2, as indicated by lack of activity on Day 3 following a Day 2 water rinse. Surprisingly treatment with MB and compounds with 2 to 3 carbons of aliphatic ester moiety (EB and nPrB) resulted in 100% nonviable J2, while compounds with 4 and 5 carbons (nBB and nPeB) killed most of the J2. Of the compounds that differed from each other in position or functional group of aromatic substitutions, M2CB, M2MB, M3MB, M3MOB and M2NB also surprisingly killed 100% of J2 while M2MOB killed more than half. Several of the tested compounds differed from each other in functional group of the aliphatic ester moiety. Of these, 100% of J2 were surprisingly nonviable in VB and 52% in iBB. BB did not show a significant difference in J2 viability from the tween control. Legend for Table 2: a) treatments were prepared at 0.095% (Trial 1) or 0.1% (Trial 2). Concentrations are referred to herein as 0.1; b) activity is defined as movement of J2 in a treatment; viability is movement of J2 after treatments were replaced with a water rinse (J2 that did not move after a water rinse were considered dead); c) means are not comparable among columns; d) treatments with zero means were not included in the analysis but are statistically different from the non-zero means at the 0.05 significance level; e) compounds differ from each other in number of carbons of aliphatic ester moiety. The number of carbons is indicated in parentheses; f) compounds differ from each other in position or functional group of aromatic substitutions; g) Compounds differ from each other in functional group of aliphatic ester moiety.

TABLE 2
Activity and viability of M incognita second-stage juveniles in methyl
benzoate (MB) and other compounds. Previously hatched J2
were immersed in aqueous solutions of the compounds.

| Treatment^{a} | % Active^{b} | % Active^{b} | % Viable^{b} |
|---|---|---|---|
| (all 0.1% except water) | Day 1^{cd} | Day 2^{cd} | Day 3 rinsed^{cd} |
| Water (control) | 93.6 ^{a} | 93.8 ^{a} | 89.2 ^{a} |
| Tween (control) | 88.5 ^{a} | 96.3 ^{a} | 88.6 ^{a} |
| MB (1 C)^{e} | 0 ^{f} | 0 ^{d} | 0 ^{e} |
| EB (2 C)^{e} | 0 ^{f} | 0 ^{d} | 0 ^{e} |
| nPrB (3 C)^{e} | 0 ^{f} | 0 ^{d} | 0 ^{e} |
| nBB (4 C)^{e} | 14.8 ^{cd} | 5.8 ^{c} | 2.9 ^{d} |
| nPeB (5 C)^{e} | 29.9 ^{bc} | 22.9 ^{b} | 16.5 ^{c} |
| nHB (6 C)^{e} | 84.5 ^{a} | 82.4 ^{c} | 66.3 ^{c} |
| M2CB^{f} | 0 ^{f} | 0 ^{d} | 0 ^{e} |
| M2MB^{f} | 2.5 ^{e} | 0 ^{d} | 0 ^{e} |
| M3MB^{f} | 0 ^{f} | 0 ^{d} | 0 ^{e} |
| M2MOB^{f} | 5.2 ^{de} | 5.9 ^{c} | 36.8 ^{b} |
| M3MOB^{f} | 0 ^{f} | 0 ^{d} | 0 ^{c} |
| M2NB^{f} | 0 ^{f} | 0 ^{d} | 0 ^{e} |
| BB^{g} | 83.2 ^{a} | 83.1 ^{a} | 79.9 ^{a} |
| iBB^{g} | 54.8 ^{ab} | 41.1 ^{b} | 42.9 ^{b} |
| VB^{g} | 0 ^{f} | 0 ^{d} | 1 ^{e} |

When M. incognita eggs were immersed in the treatments for 7 days, all of the compounds surprisingly inhibited egg hatch and suppressed J2 activity (Table 3). Seven of the nine treatments that killed all previously hatched J2 (Table 2) also resulted in 100% inactivity of J2 that hatched from eggs over the 7-day incubation period (Table 3). Additionally, nBB and nPeB treatments surprisingly resulted in 0% active J2 that hatched from immersed eggs (Table 3). The six other treatments, including nHB and BB, surprisingly also significantly decreased % active J2. With those six compounds, decreases in % active J2 ranged from 60% (iBB) to 86% (M2MOB), compared with the Tween control. Meloidogyne incognita egg hatch was surprisingly also significantly inhibited by all treatments compared with the Tween control; with most treatments this started with the Day 2 count (Table 3). By Day 7, total hatch was surprisingly significantly decreased by about 58% (M2NB) to 95% (M2CB) compared with the Tween control. Table 3 legend: a) treatments were prepared at 0.1% prior to placement in wells; concentrations were 0.095% after addition to J2 in water suspension. Concentrations are referred to herein as 0.1%; b) activity is defined as movement of J2 in a treatment; c) means are not comparable among columns; d) for % active, only the treatments that did not have all zero values were analyzed. Treatments with zero means were not included in the analysis but are statistically different from the non-zero means at the 0.05 significance level; e) compounds differ from each other in number of carbons of aliphatic ester moiety. The number of carbons is indicated in parentheses; f) compounds differ from each other in position or functional group of aromatic substitutions; g) compounds differ from each other in functional group of aliphatic ester moiety.

TABLE 3
Hatch and activity of M. incognita second-stage juveniles
in methyl benzoate (MB) and other compounds.

| Treatment^{a} | Hatch | Hatch | Hatch | % Active^{b} | % Active^{b} | % Active^{b} |
|---|---|---|---|---|---|---|
| (all 0.1% except water) | Day 2^{c} | Day 5^{c} | Day 7^{c} | Day 2^{cd} | Day 5^{cd} | Day 7^{cd} |
| Water (control) | 12.3 ^{ab} | 30.9 ^{a} | 44.5 ^{a} | 92.8 ^{a} | 96.3 ^{ab} | 95.8 ^{a} |
| Tween (control) | 14.8 ^{a} | 33.0 ^{a} | 46.0 ^{a} | 96.3 ^{a} | 97.2 ^{a} | 96.0 ^{a} |
| MB (1 C)^{e} | 2.2 ^{cd} | 3.8 ^{cde} | 4.7 ^{de} | 0 ^{c} | 0 ^{e} | 0 ^{c} |
| EB (2 C)^{e} | 2.4 ^{cd} | 3.9 ^{cde} | 4.3 ^{de} | 0 ^{c} | 0 ^{e} | 0 ^{c} |
| nPrB (3 C)^{e} | 3.5 ^{cd} | 4.0 ^{cde} | 4.1 ^{de} | 0 ^{c} | 0 ^{e} | 0 ^{c} |
| nBB (4 C)^{e} | 3.3 ^{cd} | 4.1 ^{cde} | 4.6 ^{de} | 17.1 ^{b} | 0 ^{e} | 0 ^{c} |
| nPeB (5 C)^{e} | 4.9 ^{bcd} | 6.2 ^{bcde} | 6.6 ^{cde} | 31.5 ^{b} | 0 ^{e} | 0 ^{c} |
| nHB (6 C)^{e} | 11.6 ^{ab} | 13.0 ^{b} | 13.0 ^{bc} | 73.2 ^{ab} | 40.5 ^{cd} | 16.5 ^{b} |
| M2CB^{f} | 1.7 ^{d} | 1.7 ^{e} | 2.3 ^{e} | 0 ^{c} | 0 e | 0 ^{c} |
| M2MB^{f} | 4.3 ^{cd} | 6.6 ^{bcd} | 7.6 ^{cd} | 45.3 ^{ab} | 11.8 ^{d} | 17.4 ^{b} |
| M3MB^{f} | 1.9 ^{cd} | 2.7 ^{cde} | 2.9 ^{de} | 0 ^{c} | 0 ^{e} | 0 ^{c} |
| M2MOB^{f} | 3.4 ^{cd} | 8.4 ^{bc} | 13.9 ^{bc} | 35.2 ^{ab} | 32.5 ^{cd} | 13.9 ^{b} |
| M3MOB^{f} | 2.0 ^{cd} | 2.7 ^{de} | 2.8 ^{de} | 0 ^{c} | 0 ^{e} | 0 ^{c} |
| M2NB^{f} | 5.0 ^{bcd} | 12.1 ^{b} | 19.5 ^{b} | 29.5 ^{b} | 15.2 ^{d} | 18.7 ^{b} |
| BB^{g} | 2.6 ^{cd} | 4.2 ^{cde} | 4.1 ^{de} | 67.0 ^{ab} | 33.5 ^{cd} | 24.8 ^{b} |
| iBB^{g} | 6.4 ^{abc} | 7.2 ^{bcd} | 8.2 ^{bcd} | 61.2 ^{ab} | 51.6 ^{bc} | 38.0 ^{b} |
| VB^{g} | 2.7 ^{cd} | 2.9 ^{cde} | 2.8 ^{de} | 0 ^{c} | 0 ^{e} | 0 ^{c} |

Several combinations of compounds were also tested for nematotoxicity to M. incognita J2 (Table 4). At lower rates than used in the prior assays, MB, EB, VB (0.008%) and all combination treatments surprisingly reduced % J2 activity (Day 2), compared with the controls. On Day 3 (rinsed), the lower rates of M3MB, VB (0.008%), and all combinations surprisingly reduced % J2 viability compared with the controls (Table 4). The lowest rate of VB (0.0008%) did not result in a significant reduction of % active or viable J2. Three combinations, MB/EB, MB/M3MB, and MB 0.0095%/VB 0.008%, surprisingly were highly nematotoxic and more effective than the individual compounds, killing all or most J2. The combination with the lower rate of VB (MB 0.0095%/VB 0.0008%) was also surprisingly nematotoxic, decreasing % viable J2 by 39% compared with the Tween control. For the results shown in Table 4, previously hatched J2 were immersed in aqueous solutions of the compounds. Based on results with individual compounds in previous laboratory microwell assays, concentrations were selected so that individual compounds would not result in 100% dead/inactive J2. Table 4 legend: a) final concentrations after addition to J2 in water suspension. Two trials were combined, with VB 0.0008% and MB 0.0095%/VB 0.0008% from Trial 1 only, and VB 0.008% and MB 0.0095%/VB 0.008% from Trial 2 only; b) activity is defined as movement of J2 in a treatment; viability is movement of J2 after treatments were replaced with a water rinse (J2 that did not move after a water rinse were considered dead); c) means are not comparable between columns; d) compounds differ from each other in number of carbons of aliphatic ester moiety. The number of carbons is indicated in parentheses.

TABLE 4
Activity and viability of M incognita second-stage juveniles in methyl
benzoate (MB), other compounds, and combinations.

| | % Active^{b} | % Viable^{b} |
|---|---|---|
| Treatment^{a} | Day 2^{c} | Day 3 rinsed^{c} |
| Water (control) | 95.3 ^{a} | 93.9 ^{a} |
| Tween 0.1% (control) | 94.5 ^{a} | 95.1 ^{a} |
| MB (1 C)^{d} 0.0095% | 22.4 ^{d} | 75.6 ^{ab} |
| EB (2 C)^{d} 0.025% | 42.9 ^{bc} | 80.2 ^{ab} |
| M3MB 0.015% | 66.8 ^{ab} | 63.7 ^{bc} |
| VB 0.008% | 22.4 ^{cd} | 43.1 ^{c} |
| VB 0.0008% | 90.8 ^{a} | 89.6 ^{a} |
| MB 0.0095%/EB 0.025% | 0 ^{e} | 1.0 ^{d} |
| MB 0.0095%/M3MB 0.015% | 0 ^{e} | 0 ^{e} |
| MB 0.0095%/VB 0.008% | 0 ^{e} | 0 ^{e} |
| MB 0.0095%/VB 0.0008% | 11.8 ^{d} | 58.1 ^{bc} |

Greenhouse trials with M. incognita: In studies with cucumber seedlings and MB, EB, M3MB, or VB, and combinations of these compounds, surprisingly none of the tested treatments affected shoot heights or shoot fresh weights at harvest (Table 5). Root fresh weights were also similar to the controls in most treatments. The M3MB 0.1% and VB 0.1% treatments resulted in slightly lower root weights than the controls but were not significantly different from root weights in most of the other treatments. The combinations containing these treatments surprisingly did not affect root fresh weights. Table 5 legend: a) treatments were added at a rate of 27 ml (Trial 1) and 28 ml (Trial 2) per 300 grams soil. Four replicate pots, each containing 300 grams soil, were used per treatment in each trial. Meloidogyne incognita was mixed into soil for a final inoculum of 5,000 eggs per pot. Two weeks after soil treatment, one 14-day old cucumber seedling was transplanted into each pot. Two weeks after transplant, the plants were harvested, heights and weights recorded, and root galls counted; b) means within a column followed by the same letter are not significantly different according to Tukey's adjustment for multiple comparisons (P≤0.05). Means are not comparable among columns; c) means within a column followed by the same letter are not significantly different according to a Wilcoxon test with each pair nonparametric multiple comparisons (P≤0.05); d) data were log transformed for analysis with Tukey's adjustment for multiple comparisons (P≤0.05). Untransformed data are presented to show actual numbers on roots; e) compounds differ from each other in number of carbons of aliphatic ester moiety. The number of carbons is indicated in parentheses.

TABLE 5
Effects of methyl benzoate (MB), other compounds and combinations on cucumber
(Cucumis sativus) plant vigor and gall numbers caused by M. incognita on roots.

| | | | | | | Galls per gram |
|---|---|---|---|---|---|---|
| | Shoot height (cm) | | Shoot fresh weight (g) | | Root weight (g) | root |
| Treatment^{a} | Trial 1^{b} | Trial 2^{b} | Trial 1^{b} | Trial 2^{b} | Trials 1 & 2^{c} | Trials 1 & 2^{d} |
| Water (control) | 6.6 ^{ab} | 7.1 ^{a} | 3.0 ^{a} | 3.5 ^{ab} | 3.2 ^{a} | 50.1 ^{ab} |
| Tween 0.1% (control) | 6.7 ^{ab} | 7.5 ^{a} | 3.4 ^{a} | 3.8 ^{ab} | 3.3 ^{a} | 72.8 ^{a} |
| MB (1 C)^{e} 0.1% | 7.2 ^{ab} | 8.3 ^{a} | 3.0 ^{a} | 4.0 ^{ab} | 2.9 ^{ab} | 7.4 ^{defg} |
| MB (1 C)^{e} 0.05% | 7.7 ^{ab} | 8.0 ^{a} | 3.2 ^{a} | 3.9 ^{ab} | 3.0 ^{ab} | 16.6 ^{bcde} |
| EB (2 C)^{e} 0.1% | 6.4 ^{b} | 8.1 ^{a} | 3.0 ^{a} | 4.0 ^{ab} | 3.1 ^{ab} | 34.2 ^{abc} |
| EB (2 C)^{e} 0.05% | 7.1 ^{ab} | 7.5 ^{a} | 2.8 ^{a} | 4.7 ^{a} | 3.2 ^{ab} | 22.6 ^{bcd} |
| M3MB 0.1% | 6.9 ^{ab} | 7.2 ^{a} | 3.2 ^{a} | 3.6 ^{ab} | 2.6 ^{b} | 6.8 ^{defg} |
| M3MB 0.05% | 6.8 ^{ab} | 7.9 ^{a} | 3.3 ^{a} | 4.3 ^{ab} | 3.3 ^{a} | 11.2 ^{bcdef} |
| VB 0.1% | 7.2 ^{ab} | 6.8 ^{a} | 3.0 ^{a} | 3.1 ^{b} | 2.5 ^{b} | 0.1 ^{h} |
| VB 0.05% | 6.7 ^{ab} | 8.3 ^{a} | 3.2 ^{a} | 4.3 ^{ab} | 3.1 ^{ab} | 1.8 ^{gh} |
| MB/EB/M3MB 0.1% (1:1:1) | 6.1 ^{b} | 7.2 ^{a} | 3.1 ^{a} | 3.9 ^{ab} | 3.0 ^{ab} | 7.6 ^{defg} |
| MB/EB/M3MB 0.05% (1:1:1) | 7.1 ^{ab} | 6.8 ^{a} | 3.1 ^{a} | 3.6 ^{ab} | 2.8 ^{ab} | 9.1 ^{cdef} |
| MB/EB/VB 0.1% (1:1:1) | 6.2 ^{b} | 7.8 ^{a} | 3.1 ^{a} | 4.7 ^{a} | 3.3 ^{a} | 4.3 ^{efg} |
| MB/EB/VB 0.05% (1:1:1) | 8.8 ^{a} | 7.4 ^{a} | 3.4 ^{a} | 3.4 ^{ab} | 2.8 ^{ab} | 4.1 ^{fg} |

Surprisingly, 11 of the 12 treatments significantly reduced numbers of galls per gram of root compared with the Tween control (Table 5). Reductions ranged from 53% (EB 0.1%) to nearly 100% (VB 0.1%). Surprisingly eight of the treatments (MB 0.1%, M3MB 0.1%, VB 0.1%, VB 0.05%, and all four combinations) also significantly reduced galls per gram of root compared with the water control. Surprisingly some of the individual compounds had similar activity to the combinations in reducing gall numbers. Surprisingly individual treatments of MB 0.1% and M3MB 0.1% each resulted in gall number reductions similar to those in the MB/EB/M3MB 0.1% treatment. Galls per gram of root were surprisingly also similar in the MB/EB/M3MB 0.05% treatment and each of the individual treatments. Galls per gram of root with the MB/EB/VB 0.1% combination were similar to those with MB 0.1% alone, lower than EB 0.1% alone, and higher than VB 0.1% alone. Surprisingly the MB/EB/VB 0.05% treatment resulted in fewer galls per gram of root than the MB 0.05% or EB 0.05% alone, but was similar to VB 0.05% alone.

Microwell assays with Heterodera glycines: Activity of immersed J2 surprisingly was significantly decreased by most of the treatments (Table 6). On both Day 1 and Day 2, 12 of the 15 compounds significantly reduced % active J2, compared with the Tween control. The greatest decreases in J2 activity on Day 1 and Day 2 were surprisingly in MB and VB, which each resulted in 100% inactive J2. Following the water rinse, surprisingly % viable J2 were significantly decreased in all treatments except nHB (a 6 C compound), M2MB and M2MOB, compared with the Tween control. The greatest reductions in % viable J2 were in MB and VB (100% loss of J2 viability). Of the compounds differing from each other in position or functional group of aromatic substitutions, M2CB, M3MB, M3MOB and M2NB surprisingly all killed more J2 than the Tween control, resulting in 51% (M2NB) to 99% (M2CB) reductions in % viable J2. Along with VB, the other two compounds that differed from each other in functional group of aliphatic ester moiety were surprisingly effective in killing J2: BB and iBB resulted in 33% and 43% reduction in J2 viability, respectively, compared with the Tween control. Table 6 legend: a) treatments were prepared at 0.1% prior to placement in wells; concentrations were 0.095% after addition to J2 in water suspension. Concentrations are referred to herein as 0.1%; b) activity is defined as movement of J2 in a treatment; viability is movement of J2 after treatments were replaced with a water rinse (J2 that did not move after a water rinse were considered dead); c) means are not comparable among columns; d) treatments with zero means were not included in the analysis but are statistically different from the non-zero means at the 0.05 significance level; e) compounds differ from each other in number of carbons of aliphatic ester moiety. The number of carbons is indicated in parentheses; f) compounds differ from each other in position or functional group of aromatic substitutions; g) compounds differ from each other in functional group of aliphatic ester moiety.

TABLE 6
Activity and viability of H. glycines second-stage juveniles in methyl
benzoate (MB) and other compounds. Previously hatched J2
were immersed in aqueous solutions of the compounds.

| Treatment^{a} | % Active^{b} | % Active^{b} | % Viable^{b} |
|---|---|---|---|
| (all 0.1% except water) | Day 1^{cd} | Day 2^{cd} | Day 3 rinsed^{cd} |
| Water (control) | 77.2 ^{ab} | 69.2 ^{a} | 69.2 ^{a} |
| Tween (control) | 83.3 ^{a} | 69.5 ^{a} | 61.0 ^{ab} |
| MB (1 C)^{e} | 0 ^{e} | 0 ^{h} | 0 ^{f} |
| EB (2 C)^{e} | 2.7 ^{e} | 1.8 ^{g} | 4.4 ^{e} |
| nPrB (3 C)^{e} | 17.2 ^{d} | 10.8 ^{fg} | 12.1 ^{e} |
| nBB (4 C)^{e} | 52.7 ^{c} | 24.2 ^{ef} | 26.3 ^{d} |
| nPeB (5 C)^{e} | 54.0 ^{c} | 29.1 ^{de} | 28.4 ^{d} |
| nHB (6 C)^{e} | 73.2 ^{ab} | 63.5 ^{ab} | 46.2 ^{bc} |
| M2CB^{f} | 0.46 ^{e} | 1.6 ^{g} | 0.5 ^{f} |
| M2MB^{f} | 50.4 ^{c} | 52.7 ^{bc} | 46.4 ^{bc} |
| M3MB^{f} | 10.1 ^{d} | 7.6 ^{g} | 8.5 ^{e} |
| M2MOB^{f} | 73.6 ^{ab} | 66.3 ^{ab} | 59.6 ^{ab} |
| M3MOB^{f} | 12.2 ^{d} | 10.4 ^{g} | 11.1 ^{e} |
| M2NB^{f} | 54.2 ^{c} | 34.1 ^{de} | 30.0 ^{cd} |
| BB^{g} | 66.4 ^{bc} | 60.1 ^{abc} | 41.2 ^{cd} |
| iBB^{g} | 55.6 ^{c} | 45.2 ^{cd} | 34.5 ^{cd} |
| VB^{g} | 0 ^{e} | 0 ^{h} | 0 ^{f} |

Hatch of immersed H. glycines eggs was surprisingly lower in all compounds (except M2MOB and M2NB) than in the water controls on all days, and seven compounds (MB, nPrB, nBB, M2CB, M3MB, BB and VB) surprisingly inhibited hatch compared to the Tween control on all days (Table 7). Significant hatch suppression on Day 2 (compared to the Tween control), ranged from 60% (in nPrB) to 76% (in VB). Egg hatch suppression on Day 5 was similar to that recorded on Day 7. By Day 7, eight treatments surprisingly suppressed hatch compared with the Tween control. Results with the eight compounds (MB, nPrB, nBB, M2CB, M3MB, M3MOB, BB, and VB) ranged from 64% suppression of hatch in M3MOB to 80% egg hatch suppression in VB on Day 7. Surprisingly, all J2 that hatched from the eggs were inactive on Days 2, 5 and 7 in MB, EB, M3MB and VB (Table 7). Treatment with nPrB and M2CB surprisingly resulted in 100% inactive J2 by Day 7. Surprisingly, J2 activity was significantly suppressed on Day 7 by all treatments except M2MB, compared with the controls. The significant % active J2 suppression on Day 7 ranged from 53% (in M2NB) to 100% (in six treatments), compared with the Tween control. Table 7 legend: a) treatments were prepared at 0.1% prior to placement in wells; concentrations were 0.095% after addition to J2 in water suspension. Concentrations are referred to herein as 0.1%; b) activity is defined as movement of J2 in a treatment; c) means are not comparable among columns; d) for % active, only the treatments that did not have all zero values were analyzed. Treatments with zero means were not included in the analysis but are statistically different from the non-zero means at the 0.05 significance level; e) compounds differ from each other in number of carbons of aliphatic ester moiety. The number of carbons is indicated in parentheses; f) compounds differ from each other in position or functional group of aromatic substitutions; g) compounds differ from each other in functional group of aliphatic ester moiety.

TABLE 7
Hatch and activity of Heterodera glycines second-stage juveniles in methyl benzoate
(MB) and other compounds. Eggs were immersed in aqueous solutions of the compounds.

| Treatment^{a} | Hatch | Hatch | Hatch | % Active^{b} | % Active^{b} | % Active^{b} |
|---|---|---|---|---|---|---|
| (all 0.1% except water) | Day 2^{c} | Day 5^{c} | Day 7^{c} | Day 2^{cd} | Day 5^{cd} | Day 7^{cd} |
| Water (control) | 19.8 ^{a} | 28.8 ^{a} | 29.2 ^{a} | 84.9 ^{a} | 68.1 ^{a} | 54.9 ^{a} |
| Tween (control) | 14.5 ^{ab} | 16.7 ^{ab} | 16.7 ^{ab} | 76.2 ^{ab} | 56.3 ^{ab} | 54.0 ^{a} |
| MB (1 C)^{e} | 5.4 ^{cd} | 5.6 ^{cd} | 5.5 ^{cd} | 0 ^{e} | 0 ^{f} | 0 ^{d} |
| EB (2 C)^{e} | 6.7 ^{bcd} | 6.8 ^{bcd} | 6.6 ^{bcd} | 0 ^{e} | 0 ^{f} | 0 ^{d} |
| nPrB (3 C)^{e} | 5.8 ^{cd} | 5.8 ^{cd} | 5.6 ^{cd} | 2.2 ^{d} | 0 ^{f} | 0 ^{d} |
| nBB (4 C)^{e} | 5.2 ^{cd} | 5.6 ^{cd} | 5.4 ^{cd} | 3.6 ^{d} | 9.2 ^{de} | 8.8 ^{bc} |
| nPeB (5 C)^{e} | 7.6 ^{bcd} | 7.7 ^{bcd} | 7.5 ^{bcd} | 4.2 ^{d} | 4.3 ^{e} | 4.2 ^{c} |
| nHB (6 C)^{e} | 7.3 ^{bcd} | 7.5 ^{bcd} | 7.6 ^{bcd} | 19.1 ^{cd} | 16.8 ^{cde} | 14.6 ^{bc} |
| M2CB^{f} | 5.4 ^{cd} | 5.8 ^{cd} | 5.5 ^{cd} | 0 ^{e} | 6.4 ^{de} | 0 ^{d} |
| M2MB^{f} | 6.6 ^{bcd} | 7.6 ^{bcd} | 7.4 ^{bcd} | 23.8 ^{cd} | 24.3 ^{cde} | 30.9 ^{ab} |
| M3MB^{f} | 5.2 ^{cd} | 5.4 ^{cd} | 5.1 ^{cd} | 0 ^{e} | 0 ^{f} | 0 ^{d} |
| M2MOB^{f} | 8.7 ^{abcd} | 11.3 ^{bc} | 11.6 ^{abc} | 48.2 ^{bc} | 43.0 ^{abc} | 19.1 ^{bc} |
| M3MOB^{f} | 6.3 ^{bcd} | 6.4 ^{bcd} | 6.0 ^{cd} | 0 ^{e} | 0 ^{f} | 6.9 ^{bc} |
| M2NB^{f} | 9.1 ^{abc} | 10.2 ^{bc} | 10.0 ^{bc} | 35.8 ^{c} | 28.6 ^{bcd} | 25.3 ^{bc} |
| BB^{g} | 4.1 ^{cd} | 4.5 ^{cd} | 4.6 ^{cd} | 15.2 ^{cd} | 17.0 ^{cde} | 13.5 ^{bc} |
| iBB^{g} | 6.7 ^{bcd} | 7.5 ^{bcd} | 7.3 ^{bcd} | 22.4 ^{cd} | 18.4 ^{cde} | 13.6 ^{bc} |
| VB^{g} | 3.5 ^{d} | 3.5 ^{d} | 3.4 ^{d} | 0 ^{e} | 0 ^{f} | 1 ^{d} |

Activity of previously hatched H. glycines J2 was surprisingly reduced by the tested lower rates of MB and VB (0.0095% and 0.008%, respectively), starting on Day 1 of the assays (Table 8). Following the water rinse, viability was reduced by 32% (in MB 0.0095%) and 30% (in VB 0.008%), compared with the Tween control. The lower rate treatments of EB 0.025% and M3MB 0.015% did not affect J2 activity. All of the tested combinations surprisingly reduced J2 activity and viability. By Day 3, viability was suppressed by 37% in MB 0.0095%/EB 0.025%, 20% in MB 0.0095%/M3MB 0.015%, and 65% in MB 0.0095%/VB 0.008%, compared with the Tween control. For Table 8, Previously hatched J2 were immersed in aqueous solutions of the compounds, and based on results with individual compounds in previous laboratory microwell assays, concentrations were selected so that individual compounds would not result in 100% dead/inactive J2. Table 8 legend: a) final concentrations after addition to J2 in water suspension. Based on activity of individual compounds in previous laboratory microwell assays, concentrations were selected so that individual compounds would not result in 100% dead J2; b) activity is defined as movement of J2 in a treatment; viability is movement of J2 after treatments were replaced with a water rinse (J2 that did not move after a water rinse were considered dead); c) means are not comparable among columns; d) compounds differ from each other in number of carbons of aliphatic ester moiety. Number of carbons is indicated in parentheses.

TABLE 8
Activity and viability of H. glycines second-stage juveniles in methyl
benzoate (MB), other compounds and combinations.

| | % Active^{b} | % Active^{b} | % Viable^{b} |
|---|---|---|---|
| Treatmenta | Day 1c | Day 2^{c} | Day 3 rinsed^{c} |
| Water (control) | 73.3 ^{a} | 58.4 ^{a} | 61.2 ^{ab} |
| Tween 0.1% (control) | 74.4 ^{a} | 61.7 ^{a} | 64.6 ^{a} |
| MB (1 C)^{d} 0.0095% | 49.7 ^{bc} | 27.9 ^{bc} | 43.8 ^{c} |
| EB (2 C)^{d} 0.025% | 73.9 ^{a} | 59.3 ^{a} | 52.8 ^{abc} |
| M3MB 0.015% | 71.9 ^{a} | 54.8 ^{a} | 58.7 ^{ab} |
| VB 0.008% | 42.8 ^{bc} | 34.7 ^{b} | 45.0 ^{c} |
| MB 0.0095%/EB 0.025% | 40.0 ^{c} | 33.6 ^{b} | 40.8 ^{c} |
| MB 0.0095%/M3MB 0.015% | 53.5 ^{b} | 34.2 ^{b} | 51.5 ^{bc} |
| MB 0.0095%/VB 0.008% | 18.1 ^{d} | 15.9 ^{c} | 22.6 ^{d} |

### Discussion

These studies demonstrated that applications of the selected compounds and combinations are surprisingly effective nematicides. At the tested rates, MB and 14 compounds were surprisingly antagonistic to both plant-parasitic nematodes M. incognita and H. glycines. Treatment with many of the individual compounds resulted in 100% inactive and nonviable M. incognita J2. H. glycines % J2 activity decreased in most treatments. Viability of H. glycines J2 was also significantly reduced by 12 of the 15 compounds, with up to 100% dead J2 (in MB and VB). M2MOB was active against M. incognita but did not cause significant reductions in H. glycines J2 viability. M. incognita egg hatch was surprisingly suppressed by all 15 compounds, while H. glycines hatch was significantly inhibited by eight of the compounds. Several treatment combinations surprisingly caused greater death of M. incognita J2 than the individual compounds, as did one treatment combination tested against H. glycines J2. In greenhouse trials, surprisingly the number of galls per gram of root formed by M. incognita on cucumber plants was significantly reduced by various treatments, including combinations.

As with MB, ten of the tested compounds are natural products. For example, EB is a fragrance found in flowers and various fruits (e.g., apple, banana, black currants, Feijoa fruit, grapes, peaches, sweet cherry), and is also present in butter, milk, cheese, wines, fruit brandies, black tea, and vanilla (Borgkarlson, A. K., et al., Phytochemistry, 24: 455-456 (1985); Cao, Y., et al., Journal of the institute of Brewing, 116: 182-189 (2010); Hardy, P. I., and B. J. Michael, Phytochemistry, 9: 1355-1357 (1970); Zabaleta, L., et al., International Dairy Journal, 58:23-30 (2016); CAS Database List, 2017, Ethyl Benzoate, Chemical Book (online)). EB and BB are both utilized as preservatives in cosmetics (Alvarez-Rivera, G., et al., Journal of Chromatography A, 1390: 1-12 (2015)).

In the current study, the number of carbons of aliphatic ester moiety did not greatly influence nematocidal effects of MB, EB, nPrB, nBB, and nPeB on M. incognita hatch or on active J2 that hatched during incubation in the treatments. All showed surprisingly similar nematotoxicity. The 6 C compound nHB was active but somewhat less effective than the other 5 compounds. When previously hatched J2 were immersed in the treatments, MB, EB and nPrB were the most effective of this group in decreasing J2 viability, while nHB did not have a significant effect on % viable J2. With H. glycines, the 1 C, 2 C and 3 C compounds (MB, EB and nPrB, respectively) were surprisingly overall more active than nBB, nPeB, and nHB for reducing % viability of previously hatched J2, but surprisingly all the tested compounds in this group, except nHB, effectively killed a significant number of H. glycines J2. Of these six compounds, MB, nPrB and nBB were surprisingly the most effective for suppressing H. glycines egg hatch compared to the controls, although hatch in these treatments was similar to that in the 2 C, 5 C and 6 C compounds. All six compounds reduced % active J2 that hatched from the immersed eggs, with MB, EB and nPrB surprisingly showing the greatest activity.

A second group of compounds tested in the current study differed from each other in position or functional group of aromatic substitutions. An example from that group is M3MB which is a natural organic volatile compound found in cornstalks and orange juice (Schnuitzer, G., et al AIP Conference Proceedings, 79: 1565 (2013); Zhu, W. W., et al., Fuel Processing Technology, 117: 1-7 (2014)). It is also an intermediate in some routes to the commodity chemical dimethyl terephthalate (Tomás, R A.F., et al., Chemical Reviews, 113: 7421-7469 (2013)). Every compound in this group was surprisingly active against M. incognita, with low hatch and 100% death of J2 in all but M2MOB. Differences in aromatic substitutions may have had some effect on activity against H. glycines, with greatest overall activity against this nematode surprisingly demonstrated by M2CB, M3MB, and M3MOB.

The third group of compounds differed from each other in functional group of aliphatic ester moiety. BB is a floral scent produced by petunia flowers (Orlova et al, 2006), and iBB is a natural compound found in Alpinia spp., banana, beer, cherry, cider, cocoa, and papaya (Api, A.M., et al., RIFM fragrance ingredient safety assessment, isobutyl benzoate, CAS registry number 120-50-3, Food and Chemical Toxicology, 122, Supplement 1: S372-S379 (2018). The compound VB is not a natural product. It is formed by the formal condensation of the carboxy group of benzoic acid with ethanol and is an important industrial material for producing vinyl ester polymers (Kamachi, M., et al., Polymer Bulletin, 1: 581-584 (1979)). It was also recently found that VB functions as a monomer and has a role in human cancer metabolism (Selvolini, G., and G. Marrazza, Sensors (Basel), 17: 718 (2017)). All three compounds were surprisingly active, reducing % active J2 of M. incognita and H. glycines. There were some differences in activity that might be related to aliphatic ester moiety since BB did not significantly reduce % viable J2 of M. incognita, and iBB did not significantly suppress hatch in H. glycines, but the compounds were otherwise antagonistic to the nematodes.

In summary, most of the treatments surprisingly suppressed egg hatch and killed or immobilize second-stage juveniles, and therefore have potential to suppress nematode populations on plant hosts by affecting these important stages of the nematode life cycle. Efficacy in soil was surprisingly demonstrated by reduced gall formation on plant roots with most of the tested treatments. Application of the active compounds would provide growers with environmentally friendly nematicides for managing plant-parasitic nematodes.

While the invention has been described with reference to details of the illustrated embodiments, these details are not intended to limit the scope of the invention as defined in the appended claims. The embodiment of the invention in which exclusive property or privilege is claimed is defined as follows:

What is claimed is:

1. A method for killing pests, said method comprising treating an object or area with a pest killing effective amount of a composition comprising at least one compound of formula 1 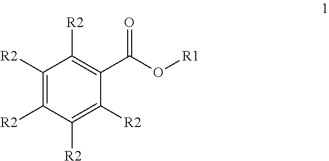
wherein R1 is CH₃, C₂H₅, C₃H₇; saturated or unsaturated, straight or branched, or halogen substituted alkyl; and wherein R2 are independently H, halogen, nitrogen, oxygen, sulfur, saturated or unsaturated, straight or branched alkyl, alkenyl, alkyl halide, aldehyde, ketone, ether, ester, amine, or amide; optionally methyl benzoate, optionally a surfactant, and optionally a carrier.

2. The method according to claim 1, wherein said carrier is selected from the group consisting of water, mineral oil, and mixtures thereof.

3. The method according to claim 1, wherein said composition consists essentially of at least one compound of formula 1, optionally methyl benzoate, optionally a surfactant, and optionally a carrier.

4. The method according to claim 1, wherein said composition consists of at least one compound of formula 1, optionally methyl benzoate, optionally a surfactant, and optionally a carrier.

5. The method according to claim 1, wherein said method consists essentially of treating an object or area with a pest killing effective amount of a composition consisting essentially of at least one compound of formula 1, optionally methyl benzoate, optionally a surfactant, and optionally a carrier.

6. The method according to claim 1, wherein said method consists essentially of treating an object or area with a pest killing effective amount of a composition consisting of at least one compound of formula 1, optionally methyl benzoate, optionally a surfactant, and optionally a carrier.

7. The method according to claim 1, wherein said method consists of treating an object or area with a pest killing effective amount of a composition consisting of at least one compound of formula 1, optionally methyl benzoate, optionally a surfactant, and optionally a carrier.

8. The method according to claim 1, wherein said at least one compound of formula 1 is the sole pesticide in said composition.

9. The method according to claim 1, wherein said at least one compound of formula 1 and optionally methyl benzoate is the sole pesticide in said composition.

10. The method according to claim 1, wherein said pests are nematodes, oomycetes, and fungi.

11. The method according to claim 1, wherein said pests are nematodes.
